(19) United States
(12) Patent Application Publication
(10) Pub. No.: US 2004/0142175 A1
(43) Pub. Date: Jul. 22, 2004

(54) Explosion-proof tempered-glass wash basin and the method for manufacturing the same

(76) Inventor: Lin Chao Shui, Chang-Hua City (TW)

Correspondence Address: LIN CHAO-SHUI, PO BOX 487, CHANG-HUA CITY, 500, TW

(21) Appl. No.: 10/347,886

(22) Filed: Jan. 22, 2003

(51) Int. Cl. B32B 9/00

(52) U.S. Cl. 428/410; 65/104; 65/106; 65/114; 428/430

(57) ABSTRACT

An explosion-proof tempered-glass wash basin is manufactured by the following steps. At first, a flat glass is made as a wash-basin has a predetermined shape. For example, a wash-basin having a round shape is used as an example. Secondary, the tempered glass is strengthened. Thirdly, a bottom of the tempered glass is adhered with a layer of explosion-proof film. Thus an explosion-proof tempered-glass wash basin is formed.

### FIELD OF THE INVENTION

The present invention relates to wash-basins, and particularly to a explosion-proof tempered-glass wash basin.

### BACKGROUND OF THE INVENTION

It is often occurred that people are hurt by wash-basins because the wash-basins are not well fixed and thus fall down after being used for a long time period.

To improve above mentioned defects, tempered glasses are used to manufacture wash-basins. However, when the compressing stress layer of the tempered glass is damaged due to for example collision, transfer, or package, the surface of the tempered glass will have cracks so that the tempered glass will break and thus a great amount of small particle like pieces will generate so as to hurt the human bodies.

Furthermore, in another prior art, two pieces of tempered glasses are glued together so as to be formed as a wash-basin. This prior art suffers from a defect, that is, the two tempered glasses can not be precisely combined, thus too many defected products are generated so that the cost is increased. Moreover, the manufacturing time period is too long, even two days are necessary. Thereby, the cost is further increased. Thus, the price is high.

### SUMMARY OF THE INVENTION

Accordingly, the primary object of the present invention is to provide an explosion-proof tempered-glass wash basin manufactured by the following steps. At first, a flat glass is made as a wash-basin has a predetermined shape, for example, a wash-basin having a round shape is used as an example. Secondary, the tempered glass is strengthened. Thirdly, a bottom of the tempered glass is adhered with a layer of explosion-proof film.

The various objects and advantages of the present invention will be more readily understood from the following detailed description when read in conjunction with the appended drawing.

### BRIEF DESCRIPTION OF THE DRAWINGS

FIG. 1 shows the block diagram of the present invention.

FIG. 2 is a schematic view showing the product of the present invention.

FIG. 3 is a cross sectional view of the present invention.

FIG. 4 is a schematic view showing that in the present invention, an explosion-proof film is sprayed to the tempered glass explosion-proof.

FIG. 5 is a schematic view showing that in the present invention, an explosion proof film is showered to the tempered glass explosion-proof.

### DETAILED DESCRIPTION OF THE PREFERRED EMBODIMENTS

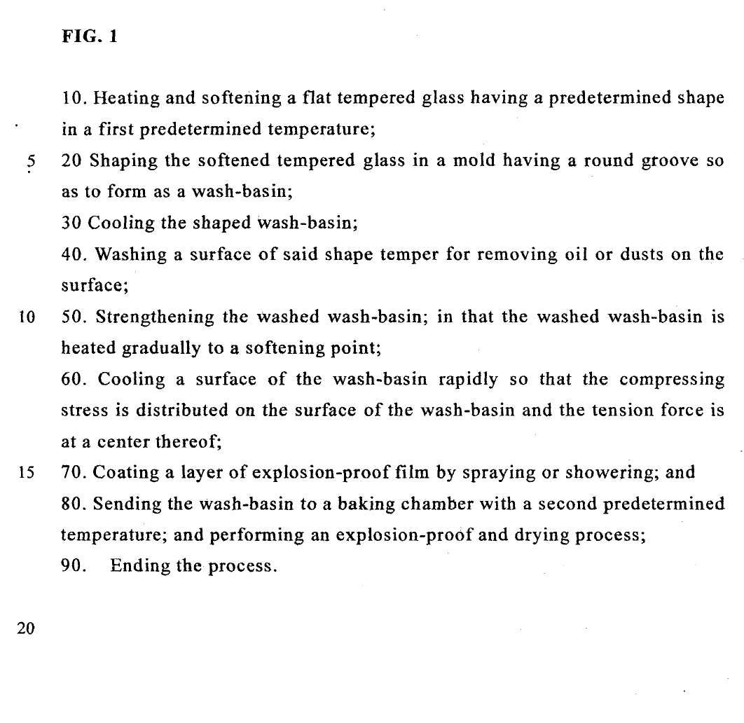

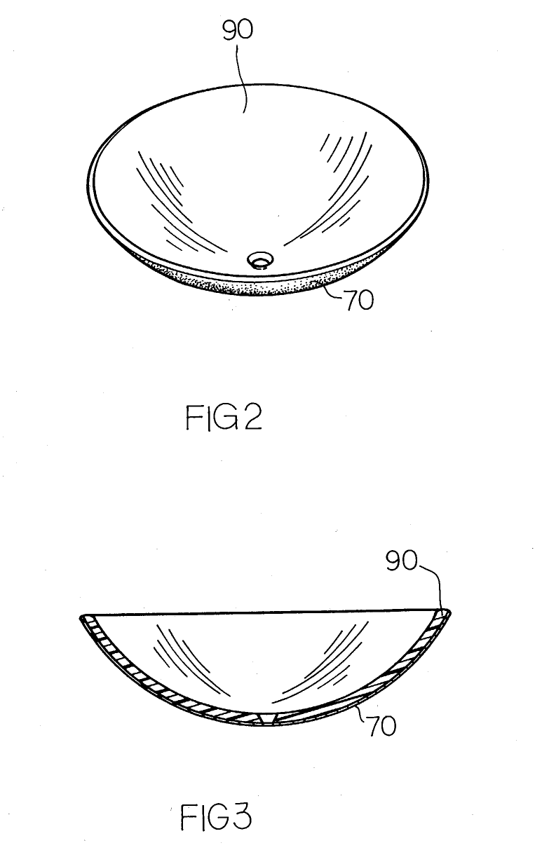

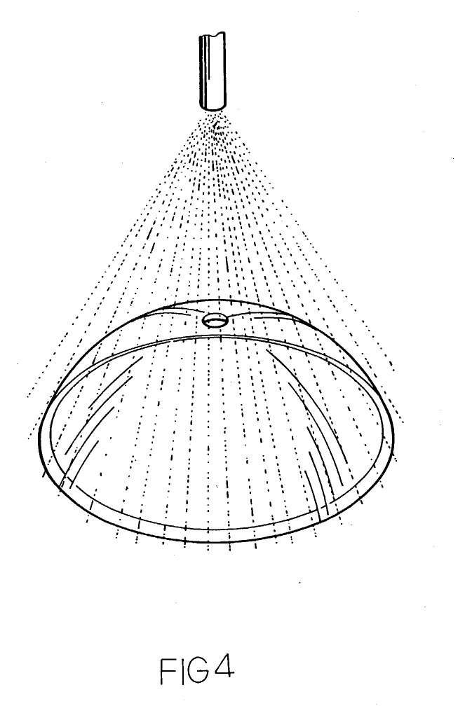

Referring to FIGS. 1 to 3, the explosion-proof tempered-glass wash basin according to the present invention is manufactured by the following steps:

At first, a flat glass is made as a wash-basin has a predetermined shape, in this embodiment, a wash-basin having a round shape is used as an example.

Secondary, the tempered glass is strengthened.

Thirdly, a bottom of the tempered glass is adhered with a layer of explosion-proof film.

The details of above mentioned steps are further described herein with reference to FIG. 1. This contains the step of:

Heating and softening a flat glass having a predetermined shape in a temperature of 720° C., step 10;

Shaping the soft tempered glass in a mold having a round groove so as to form as a wash-basin, step 20;

Cooling the shaped wash-basin, step 30;

Washing a surface of the shape temper for removing oil or dusts on the surface; step 40;

Strengthening the washed wash-basin; in that the washed wash-basin is heated gradually to a softening point; step 50;

Cooling a surface of the wash-basin rapidly so that the compressing stress is distributed on the surface of the wash-basin and the tension force is at a center thereof (step 60). In this design, as a large force is applied to the wash-basin, the tension force will be cancelled by the compressing stress. In the process of strengthening the wash-basin, the blowing hot air is according to the width and thickness of the glass and the direction and temperature of the blowing air. Moreover, in cooling process, the air blowing direction is changed circularly;

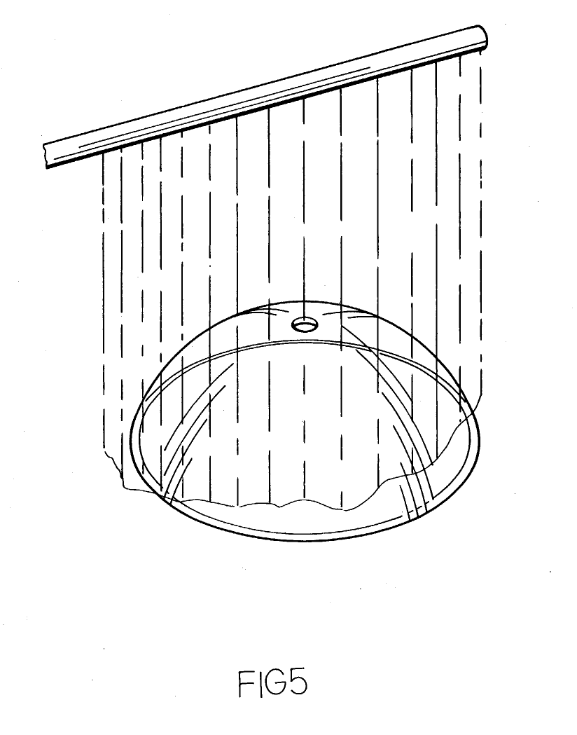

Coating a layer of explosion-proof film by spraying (referring to FIG. 4) or showering (referring to FIG. 5); step 70;

Sending the wash-basin to a baking chamber with a predetermined temperature of 200° C. ; and performing an explosion-proof and drying process to the wash-basin through a time period of about 20 minutes so that the explosion-proof film is transparent and adhered to a bottom of the wash-basin to achieve the object of enhancing the ability of the wash-basin for suffering from a tension force; step 80; and

Ending the process to form a wash-basin; step 90.

Thereby, when the wash-basin is broken, it will not hurt anybody due to the explosion-proof film. The explosion-proof film of the present invention is a liquid resin which is formed by alcohol and toluene with a predetermined ratio or the explosion-proof film is made of PC.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing an explosion-proof tempered-glass wash basin comprising the steps of:
heating and softening a flat tempered glass having a predetermined shape in a first predetermined temperature;
shaping the softened tempered glass in a mold having a round groove so as to form as a wash-basin;
cooling the shaped wash-basin;
washing a surface of the shape temper for removing oil or dusts on the surface;
strengthening the washed wash-basin; in that the washed wash-basin is heated gradually to a softening point;
cooling a surface of the wash-basin rapidly so that the compressing stress is distributed on the surface of the wash-basin and the tension force is at a center thereof;
coating a layer of explosion-proof film by spraying or showering; and
sending the wash-basin to a baking chamber with a second predetermined temperature; and performing an explosion-proof and drying process to the wash-basin through a predetermined time period so that the explosion-proof film is transparent and adhered to a bottom of the wash-basin to form a wash-basin.

2. The method of claim 1, wherein the explosion-proof film is a liquid resin.

3. The method of claim 2, wherein the liquid resin is formed by alcohol and toluene with a predetermined ratio.

4. An explosion-proof tempered-glass wash basin made from the following steps: heating and softening a flat tempered glass having a predetermined shape in a first predetermined temperature; shaping the softened tempered glass in a mold having a round groove so as to form as a wash-basin; cooling the shaped wash-basin; washing a surface of said shape temper for removing oil or dusts on the surface; strengthening the washed wash-basin; in that the washed wash-basin is heated gradually to a softening point; cooling a surface of the wash-basin rapidly so that the compressing stress is distributed on the surface of the wash-basin and the tension force is at a center thereof; coating a layer of explosion-proof film by spraying or showering; and sending the wash-basin to a baking chamber with a second predetermined temperature; and performing an explosion-proof and drying process to the wash-basin through a predetermined time period so that the explosion-proof film is transparent and adhered to a bottom of the wash-basin to form a wash-basin.

5. The explosion-proof tempered-glass wash basin of claim 4, wherein the explosion-proof film is a liquid resin.

6. The explosion-proof tempered-glass wash basin of claim- 5, wherein the liquid resin is formed by alcohol and toluene with a predetermined ratio.
